(19) United States
(12) Patent Application Publication
(10) Pub. No.: US 2026/0034447 A1
(43) Pub. Date: Feb. 5, 2026

(54) METHOD FOR ACQUIRING VIRTUAL EQUIPMENT, COMPUTER DEVICE, AND STORAGE MEDIUM

(71) Applicant: TENCENT TECHNOLOGY (SHENZHEN) COMPANY LIMITED, Shenzhen (CN)

(72) Inventor: Yue LIU, Shenzhen (CN)

(21) Appl. No.: 19/356,741

(22) Filed: Oct. 13, 2025

Related U.S. Application Data
(63) Continuation of application No. PCT/CN2024/113552, filed on Aug. 21, 2024.

(30) Foreign Application Priority Data
Oct. 18, 2023 (CN) 202311348470.2

(51) Int. Cl. A63F 13/53

(52) U.S. Cl. CPC A63F 13/53

(57) ABSTRACT

A method for acquiring virtual equipment performed by a computer device includes: displaying a virtual scene, the virtual scene including a first virtual character and a second virtual character, the first virtual character being controlled by the computer device, and the second virtual character being controlled by another computer device; displaying an information display area of the second virtual character in response to receiving a trigger operation on a character image of the second virtual character, the information display area including virtual equipment information currently worn by the second virtual character; and displaying equipment acquisition information corresponding to a first equipment in response to receiving a trigger operation on the first equipment in the information display area, the equipment acquisition information including an acquisition entry of the first equipment when the first equipment meets an equipment acquisition condition.

### CROSS-REFERENCES TO RELATED APPLICATIONS

This application is a continuation application of PCT Patent Application No. PCT/CN2024/113552, filed on Aug. 21, 2024, which claims priority to Chinese Patent Application No. 202311348470.2, filed on Oct. 18, 2023, all of which is incorporated herein by reference in their entirety.

### FIELD OF THE TECHNOLOGY

The present disclosure relates to the field of virtual scenes, and in particular, to a method and apparatus for acquiring virtual equipment, a device, a medium, and a program product.

### BACKGROUND OF THE DISCLOSURE

In a game application, a player may have his own virtual character, and the virtual character represents an in-game avatar. The player may dress up the virtual character using virtual equipment provided by the game platform.

In the related technologies, a player may control a main control virtual character to interact with a virtual character controlled by another player in a virtual scene. When player A is interested in equipment of a virtual character controlled by player B, the player A usually needs to memorize the equipment (e.g., by taking a screenshot form), and then search for the equipment in an equipment acquisition platform of the game, to obtain equipment information, and may further acquire the equipment.

However, in the related technologies, the process for the player to obtain the equipment is redundant and cumbersome, resulting in low efficiency in acquiring equipment.

### SUMMARY

One embodiment of the present disclosure provides a method for acquiring virtual equipment performed by a computer device. The method includes: displaying a virtual scene, the virtual scene including a first virtual character and a second virtual character, the first virtual character being controlled by the computer device, and the second virtual character being controlled by another computer device; displaying an information display area of the second virtual character in response to receiving a trigger operation on a character image of the second virtual character, the information display area including virtual equipment information currently worn by the second virtual character; and displaying equipment acquisition information corresponding to a first equipment in response to receiving a trigger operation on the first equipment in the information display area, the equipment acquisition information including an acquisition entry of the first equipment when the first equipment meets an equipment acquisition condition.

Another embodiment of the present disclosure provides a computer device. The computer device includes one or more processors and a memory containing at least one instruction that, when being executed, causes the one or more processors to perform: displaying a virtual scene, the virtual scene including a first virtual character and a second virtual character, the first virtual character being controlled by the computer device, and the second virtual character being controlled by another computer device; displaying an information display area of the second virtual character in response to receiving a trigger operation on a character image of the second virtual character, the information display area including virtual equipment information currently worn by the second virtual character; and displaying equipment acquisition information corresponding to a first equipment in response to receiving a trigger operation on the first equipment in the information display area, the equipment acquisition information including an acquisition entry of the first equipment when the first equipment meets an equipment acquisition condition.

Another embodiment of the present disclosure provides a non-transitory computer-readable storage medium containing at least one instruction that, when being executed, causes at least one processor to perform: displaying a virtual scene, the virtual scene including a first virtual character and a second virtual character, the first virtual character being controlled by the computer device, and the second virtual character being controlled by another computer device; displaying an information display area of the second virtual character in response to receiving a trigger operation on a character image of the second virtual character, the information display area including virtual equipment information currently worn by the second virtual character; and displaying equipment acquisition information corresponding to a first equipment in response to receiving a trigger operation on the first equipment in the information display area, the equipment acquisition information including an acquisition entry of the first equipment when the first equipment meets an equipment acquisition condition.

### BRIEF DESCRIPTION OF THE DRAWINGS

FIG. 1 is a structural block diagram of a computer system according to an exemplary embodiment of the present disclosure.

FIG. 2 is a schematic diagram of an implementation environment according to an exemplary embodiment of the present disclosure.

FIG. 3 is a flowchart of a method for acquiring virtual equipment according to an exemplary embodiment of the present disclosure.

FIG. 4 is a schematic diagram of a display of an information display area according to an exemplary embodiment of the present disclosure.

FIG. 5 is a schematic diagram of an interface of a method for acquiring a virtual clothing according to an exemplary embodiment of the present disclosure.

FIG. 6 is a flowchart of a method for acquiring virtual equipment according to another exemplary embodiment of the present disclosure.

FIG. 7 is a flowchart of a method for acquiring virtual equipment according to yet another exemplary embodiment of the present disclosure.

FIG. 8 is an interaction flowchart of a method for acquiring virtual equipment according to an exemplary embodiment of the present disclosure.

FIG. 9 is a structural block diagram of an apparatus for acquiring virtual equipment according to an exemplary embodiment of the present disclosure.

FIG. 10 is a structural block diagram of an apparatus for acquiring virtual equipment according to another exemplary embodiment of the present disclosure.

FIG. 11 is a structural block diagram of a computer device according to an exemplary embodiment of the present disclosure.

### DESCRIPTION OF EMBODIMENTS

In the related art, a player may control a main control virtual character to interact with a virtual character controlled by another player in a virtual scene. When a player A is interested in equipment of a virtual character controlled by a player B, the player A usually needs to memorize the equipment (e.g., in a screenshot form), and then searches for the equipment in an equipment acquisition platform of the game, to learn of equipment information of the equipment, and may further acquire the equipment. However, in the related art, a path for the player to acquire the equipment is redundant and complex, and an equipment acquisition efficiency is low.

An embodiment of the present disclosure provides a method for acquiring virtual equipment. After receiving a trigger operation on a virtual character corresponding to another computer device in a virtual scene, information of virtual equipment currently worn by the second virtual character is displayed in an information display area corresponding to the virtual character, such that a player can quickly view a virtual equipment status of another virtual character without the need to additionally open another entry to learn the virtual equipment status, thereby improving a human-computer interaction efficiency. In addition, after a trigger operation on the first equipment in the information display area is received, equipment acquisition information corresponding to the first equipment may be displayed, thereby allowing the player to conveniently learn an acquisition path of virtual equipment worn by the another virtual character. In addition, when the first equipment meets an equipment acquisition condition, the equipment acquisition information includes an acquisition entry of the first equipment, which provides an entry for the player to rapidly acquire the first equipment, thereby reducing operations of acquiring the equipment, and improving the efficiency of acquiring the virtual equipment.

A terminal in the present disclosure may be a desktop computer, a laptop computer, a mobile phone, a tablet computer, an e-book reader, a moving picture experts group audio layer III (MP3) player, a moving picture experts group audio layer IV (MP4) player, or the like. An application program supporting a virtual scene, such as an application program supporting a three-dimensional virtual scene, is installed and run on the terminal. The application program may be any one of a virtual reality application program, the third-person shooting (TPS) game, the first-person shooting (FPS) game, multiplayer online battle arena (MOBA) games, a massive multiplayer online role-playing game (MMORPG), a turn-based action game, or the like.

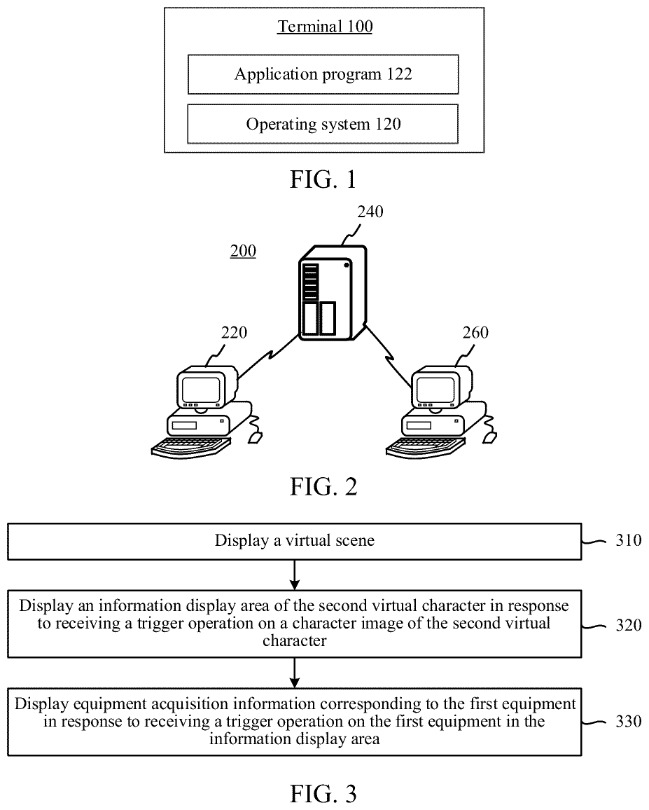

FIG. 1 is a structural block diagram of an electronic device according to an exemplary embodiment of the present disclosure. An electronic device 100 includes an operating system 120 and an application program 122.

The operating system 120 is basic software that provides secure access to computer hardware for the application program 122.

The application program 122 is an application program supporting a virtual scene. The application program 122 may be any one of a virtual reality application program, a TPS game, an FPS game, a multiplayer online battle arena game, a massive multiplayer online role-playing game, a turn-based action game, or the like. The application program 122 may be a standalone application program, such as a standalone three-dimensional game program, or may also be a network-connected application program.

FIG. 2 is a structural block diagram of a computer system according to an exemplary embodiment of the present disclosure. The computer system 200 includes: the first terminal 220, a server 240, and the second terminal 260.

An application program supporting a virtual scene is installed and run on the first terminal 220. The application program may be any one of a virtual reality application program, a TPS game, an FPS game, a multiplayer online battle arena game, a massive multiplayer online role-playing game, a turn-based action game, or the like. The first terminal 220 is a terminal used by the first user. The first user uses the first terminal 220 to control the first virtual character in the virtual scene to perform an action. The action includes, but is not limited to, at least one of body posture adjustment, crawling, walking, running, cycling, jumping, driving, picking, shooting, attacking, or throwing. Illustratively, the first virtual character is the first virtual character such as a simulated character role or a cartoon character role.

The first terminal 220 is connected to the server 240 through a wireless network or a wired network.

The server 240 includes at least one of one server, a plurality of servers, a cloud computing platform, or a virtualization center. The server 240 is configured to provide a backend service for an application program supporting the virtual scene. In some embodiments, the server 240 undertakes main computing work, and the first terminal 220 and the second terminal 260 undertake secondary computing work. Alternatively, the server 240 undertakes secondary computing work, and the first terminal 220 and the second terminal 260 undertake main computing work. Alternatively, the server 240, the first terminal 220, and the second terminal 260 perform collaborative computing by using a distributed computing architecture.

An application program supporting the virtual scene is installed and run on the second terminal 260. The application program may be any one of a virtual reality application program, a TPS game, an FPS game, a multiplayer online battle arena game, a massive multiplayer online role-playing game, a turn-based action game, or the like. The second terminal 260 is a terminal used by the second user. The second user uses the second terminal 260 to control the second virtual character in the virtual scene to perform an action. The action includes, but is not limited to, at least one of body posture adjustment, crawling, walking, running, cycling, jumping, driving, picking, shooting, attacking, or throwing. Illustratively, the second virtual character is the second virtual character, such as a simulated character role or a cartoon character role.

In some embodiments, the first virtual character and the second virtual character are in the same virtual scene. In some embodiments, the first virtual character and the second virtual character may belong to the same team and the same organization, and have a friend relationship or a temporary communication permission. In some embodiments, the first virtual character and the second virtual character may also belong to different teams, different organizations, or two antagonistic groups.

In some embodiments, the application programs installed on the first terminal 220 and the second terminal 260 may be the same, or the application programs installed on the two terminals are application programs of the same type on different control system platforms. The first terminal 220 may generally refer to one of a plurality of terminals, and the second terminal 260 may generally refer to another of the plurality of terminals. This embodiment only uses the first terminal 220 and the second terminal 260 as examples. Terminal types of the first device 220 and the second device 260 is the same or is different. The terminal type includes at least one of a game console, a desktop computer, a smartphone, a tablet computer, an e-book reader, an MP3 player, an MP4 player, or a laptop computer.

A person skilled in the art may know that there may be more or fewer of the foregoing terminals. For example, there may be only one terminal, or there may be dozens of or hundreds of the foregoing terminals or more. This embodiment of the present disclosure does not limit the number of terminals or the terminal type.

The server 240 may be an independent physical server, or may be a server cluster or distributed system composed of a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence platform.

In the present disclosure, before and during acquisition of relevant data of a user, a prompt interface or a pop-up window may be displayed, or speech prompt information may be outputted. The prompt interface, the pop-up window, or the speech prompt information is configured for prompting the user that the relevant data of the user is currently being collected. In this way, in the present disclosure, only after a confirmation operation performed by the user for the prompt interface or the pop-up window is acquired, the relevant operations of acquiring the relevant data of the user start to be performed. Otherwise (in other words, when the confirmation operation performed by the user for the prompt interface or the pop-up window is not acquired), the relevant operations of acquiring the relevant data of the user are ended, that is, the relevant data of the user is not acquired. In other words, all user data acquired in the present disclosure is acquired with user consent and authorization, and acquisition, use, and processing of relevant user data need to comply with relevant laws, regulations, and standards.

In combination with the foregoing introduction and implementation environment, FIG. 3 is a flowchart of a method for acquiring virtual equipment according to an embodiment of the present disclosure. Description is made by using an example in which the method is applied to a terminal. As shown in FIG. 3, the method includes operation 310 to operation 330 described below.

Operation 310: Display a virtual scene.

The virtual scene includes the first virtual character and the second virtual character, the first virtual character is a virtual character controlled by a computer device (e.g., a terminal), and the second virtual character is a virtual character controlled by another computer device.

In some embodiments, the current computer device is the first terminal, the first account is logged in on an application program running on the first terminal, and the first virtual character is a virtual character corresponding to the first account; and the another computer device is the second terminal, the second account is logged in on an application program running on the second terminal, and the second virtual character is a virtual character corresponding to the second account. Illustratively, the application program may be any one of a virtual reality application program, a TPS game, an FPS game, a multiplayer online battle arena game, a massive multiplayer online role-playing game, a turn-based action game, or the like.

In some other embodiments, the second virtual character is implemented as a virtual character controlled by a system, such as a non-player character (NPC), and an artificial intelligence (AI) character. That is, the second virtual character is not a manually controlled character, but is a character that automatically performs actions.

In some embodiments, the first virtual character and the second virtual character both wear virtual equipment. The virtual equipment refers to digital equipment (or understood as non-physical equipment) provided in an application program, and the virtual equipment includes at least one of two-dimensional virtual equipment, three-dimensional virtual equipment, or the like. Illustratively, the virtual equipment includes a virtual prop (e.g., virtual armor), a virtual accessory (e.g., a virtual clothing or a virtual hair accessory), a virtual vehicle, and the like. Types and a quantity of the virtual equipment are not limited in this embodiment of the present disclosure.

Operation 320: Display an information display area of the second virtual character in response to receiving a trigger operation on a character image of the second virtual character.

In some embodiments, the foregoing trigger operation includes at least one of a click/tap operation, a long-press operation, a swipe operation, a voice instruction operation, a gesture instruction operation, or the like, which is not limited in this embodiment of the present disclosure.

In some embodiments, the information display area includes character information of the second virtual character, such as an account name, an account level, or an account avatar of an account corresponding to the second virtual character. The information display area further includes an interaction function button, where the interaction function button is configured to implement interaction between the first account and the account corresponding to the second virtual character. The interaction function button includes a friend adding function button, a team forming function button, a chat function button, and the like, which is not limited in this embodiment of the present disclosure.

In some embodiments, the information display area includes a two-dimensional display area, a three-dimensional display area, and the like. This embodiment of the present disclosure does not impose any limitation in this regard.

Illustratively, the information display area includes an information pop-up window, an information floating window, and the like. In some embodiments, the information display area has a corresponding transparency, and the transparency may be set as a preset transparency, such that the information display area does not block the display of a scene picture of the virtual scene.

Illustratively, the foregoing virtual scene may be implemented as a scene of a “main city” in a game. When a player sees another virtual character (i.e., the second virtual character) in the “main city”, the player may click/tap a character image of the virtual character, and the information display area corresponding to the virtual character may be displayed after the click/tap.

The information display area includes virtual equipment information (i.e., information about virtual equipment) currently worn by the second virtual character.

In some embodiments, the virtual equipment information is attribute content of the virtual equipment currently worn by the second virtual character. The virtual equipment information includes at least one of a plurality of types of information such as an equipment icon, an equipment picture, an equipment name, and an equipment type of the virtual equipment, which is not limited in this embodiment of the present disclosure.

Illustratively, the second virtual character currently wears a virtual jacket, virtual pants, and virtual boots. The information display area is displayed after clicking/tapping the character image of the second virtual character, and wearing details of the second virtual character are displayed in the information display area, for example, pictures of the virtual jacket, the virtual pants, and the virtual boots currently worn by the second virtual character are displayed.

In some embodiments, the information display area includes virtual equipment information about all virtual equipment currently worn by the second virtual character; or, the information display area includes information about some virtual equipment information currently worn by the second virtual character.

In some embodiments, if the second virtual character currently wears multiple pieces of virtual equipment, virtual equipment information respectively corresponding to the multiple pieces of virtual equipment is displayed in the information display area.

In some embodiments, the multiple pieces of virtual equipment are arranged in the information display area according to a preset wearing sequence. Illustratively, when the virtual equipment is implemented as a virtual clothing, the preset wearing sequence is a sequence determined based on a clothing type. For example, the preset wearing sequence is a hat, an upper garment, a lower garment, shoes, socks, and an accessory, and accordingly, a hat, a jacket, pants, shoes, socks, a packsack, and the like worn by the second virtual character are sequentially displayed in the information display area according to the preset wearing sequence.

In some embodiments, the information display area includes an equipment outfit display sub-area, and the equipment outfit display sub-area is configured to display the information about the virtual equipment currently worn by the second virtual character.

Illustratively, when a trigger operation on the character image of the second virtual character is received to display the information display area, the information about the virtual equipment currently worn by the second virtual character is displayed in the equipment outfit display sub-area in the information display area. The equipment outfit display sub-area is a preset display sub-area in the information display area. For example, the information display area is a large rectangular area, and the equipment outfit display sub-area is a small rectangular area preset to be displayed at an upper left corner.

In some embodiments, when the second virtual character currently wears one piece of virtual equipment, virtual equipment information corresponding to only one piece of virtual equipment is displayed in the equipment outfit display sub-area based on the trigger operation (which may be referred to as displaying one piece of virtual equipment for short); and when the second virtual character currently wears multiple pieces of virtual equipment, virtual equipment information respectively corresponding to the multiple pieces of virtual equipment is displayed in the equipment outfit display sub-area based on the trigger operation (which may be referred to as displaying the multiple pieces virtual equipment for short).

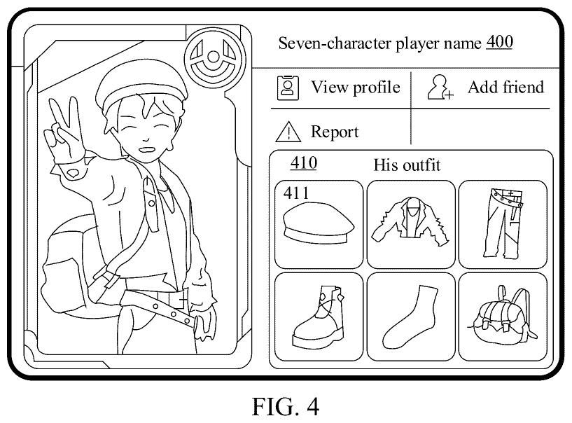

In some embodiments, the multiple pieces of virtual equipment are separately displayed individually in the equipment outfit display sub-area. Illustratively, referring to FIG. 4, FIG. 4 is a schematic diagram of a display of an information display area. An information display area 400 includes an equipment outfit display sub-area 410. Individual item pictures of multiple pieces of virtual equipment corresponding to the second virtual character are displayed in the equipment outfit display sub-area 410. For example, a picture 411 is an individual item picture of a virtual hat currently worn by the second virtual character.

Displaying the virtual equipment individually helps the player to learn of the multiple pieces of virtual equipment one by one, and also helps the player to compare the multiple pieces of virtual equipment more intuitively, thereby allowing the player to perform a more targeted operation of triggering the display of equipment acquisition information, and improving the accuracy of triggering the display of the equipment acquisition information.

In some embodiments, the multiple pieces of virtual equipment are displayed in a combined manner with a coordinated form in the equipment dressing display sub-region. Illustratively, a combined picture of at least two of the multiple pieces of virtual equipment corresponding to the second virtual character is displayed in the equipment outfit display sub-area. For example, a combined picture 1 displays an upper-body outfit (including a virtual hat, a virtual jacket, a virtual packsack, etc.) of the second virtual character; or, a combined picture 2 displays a lower-body outfit (including a virtual belt, virtual pants, virtual shoes, etc.) of the second virtual character; or, a combined picture 3 displays a full-body outfit (including the upper-body outfit and the lower-body outfit) of the second virtual character. This is not limited herein.

Displaying the virtual equipment in a coordinated form improves the richness of the displayed virtual equipment information to some extent. In addition, the player can learn of the equipment acquisition information of the multiple pieces of virtual equipment, or the equipment acquisition information of a combination of at least two pieces of virtual equipment through a single trigger operation, thereby improving display flexibility of the equipment acquisition information, and also improving the efficiency of triggering the display of the equipment acquisition information.

In some embodiments, the multiple pieces of virtual equipment are displayed by category in the equipment outfit display sub-area. For example, the equipment outfit display sub-area includes at least one of the first display area, the second display area, or the third display area, the first display area displays a virtual prop, the second display area displays a virtual accessory, and the third display area displays a virtual vehicle.

In some embodiments, the first account is logged in on a computer device (e.g., a terminal); and the information display area includes the second equipment currently worn by the second virtual character.

When the first account logged in on the computer device owns the second equipment, the information display area further includes the first marking information, and the first marking information is configured for indicating that the first account owns the second equipment.

In some embodiments, the information about the virtual equipment currently worn by the second virtual character is displayed in the equipment outfit display sub-area of the information display area. Therefore, when the first account owns the second equipment, the first marking information is also included in the equipment outfit display sub-area for indicating that the first account owns the second equipment.

Illustratively, the virtual clothing currently worn by the second virtual character is displayed in the equipment outfit display sub-area. If a virtual upper garment is virtual equipment owned by the first account corresponding to the first virtual character, an “owned” identifier is displayed on a picture corresponding to the virtual equipment, indicating that the first account already owns the virtual upper garment.

By displaying the first marking information within an information display page, the player can more intuitively learn of a possession status of the virtual equipment worn by the second virtual character, thereby preventing, to some extent, the player from repeatedly purchasing the virtual equipment, also helping encourage the player to purchase virtual equipment that the player does not possess, avoiding a complex operation in which the player additionally opens another entry to learn of the possession status of the second equipment, and improving the human-computer interaction efficiency.

In some other embodiments, a trigger operation on the character image of the second virtual character is received when a distance between the first virtual character and the second virtual character is less than or equal to a preset distance; and the information display area of the second virtual character is displayed in response to the trigger operation on the character image of the second virtual character.

In some embodiments, an area display function of displaying the information display area based on the trigger operation is a function activated when a character distance is less than or equal to the preset distance.

Illustratively, when the distance between the first virtual character and the second virtual character is greater than the preset distance, the area display function is inactive, that is, even if the trigger operation on the character image of the second virtual character is received, the information display area of the second virtual character is not displayed. When the distance between the first virtual character and the second virtual character is less than or equal to the preset distance, the area display function is automatically activated, that is, the information display area of the second virtual character is displayed when the trigger operation on the character image of the second virtual character is received.

In some embodiments, the trigger operation on the character image of the second virtual character is implemented as an automatically triggered operation.

Illustratively, the player may control the first virtual character to approach the second virtual character in the virtual scene. When the distance between the first virtual character and the second virtual character is less than or equal to the preset distance, the terminal is deemed to automatically performs the trigger operation on the character image of the second virtual character, and therefore the information display area of the second virtual character is automatically displayed.

By setting the preset distance as a display condition of the information display area, the preset distance may be used as an activation condition of the area display function, to improve diversity of image display. Alternatively, the preset distance may be used as a display condition for automatically displaying the information display area, such that the player may view the information display area of the second virtual character more efficiently in a mode of controlling the first virtual character to approach the second virtual character. The player may also control, in the same mode, the first virtual character to approach another virtual character, to automatically view an information display area corresponding to the another virtual character without an additional trigger operation, thereby greatly improving the human-computer interaction efficiency.

In some embodiments, the forgoing equipment outfit display sub-area is an area displayed when the first account meets a preset interaction condition.

The preset interaction condition is a preset condition for limiting a display status of the equipment outfit display sub-area. In some embodiments, the preset interaction condition includes at least one of the following cases: (1) an account level of the first account reaches a preset level; (2) a character proficiency of the first virtual character corresponding to the first account reaches a preset proficiency threshold; (3) an intimacy level between the first account and another account is greater than or equal to an intimacy threshold; (4) a character position of the first virtual character corresponding to the first account is within a preset range; or (5) an account attribute of the first account is higher than an account attribute of the second account, the account attribute including attributes such as an account level, and a virtual mana value, a virtual blood volume, and virtual fighting power of a virtual character corresponding to an account.

In some embodiments, when the first account meets the preset interaction condition, the information display area includes the equipment outfit display sub-area.

Illustratively, when the first account does not meet the preset interaction condition, the information display area is displayed but the equipment outfit display sub-area is not displayed, that is, the information about the virtual equipment currently worn by the second virtual character cannot be displayed through the information display area. When the first account meets the preset interaction condition, the information display area including the equipment outfit display sub-area is displayed, to display the information about the virtual equipment currently worn by the second virtual character.

In some embodiments, when an intimacy level between the first account logged in on the computer device and another account logged in on another computer device (i.e., an account corresponding to the second virtual character) is greater than or equal to the intimacy threshold, the information about the virtual equipment currently worn by the second virtual character is displayed in the information display area.

The intimacy level is configured for representing an account interaction degree between the first account and another account. The intimacy level may be represented by a level (e.g., a high intimacy level, a medium intimacy level, and a low intimacy level), or may also be represented by a value (e.g., an intimacy level of 100, an intimacy level of 92, or an intimacy level of 55). Illustratively, the intimacy level is determined based on a number of interactions between the first account and the another account, for example, if the first account and the another account have a daily conversation, the intimacy level between the first account and the another account is 95, and if the first account and the another account have a weekly conversation, the intimacy level between the first account and the another account is 80; and/or, the intimacy level is determined based on an interaction mode between the first account and the another account. The interaction mode includes a conversation, a video, or the like, etc. For example, if the first account and the another account have a daily video, the intimacy level between the first account and the another account is 98. If the first account and the another account have a daily conversation, the intimacy level between the first account and the another account is 90. An acquisition mode and a representation mode of the intimacy level are not limited herein.

Illustratively, the intimacy level between the first account and the another account is analyzed in real time; or, the intimacy level between the first account and the another account is analyzed in response to receiving the trigger operation on the character image of the second virtual character.

Illustratively, the intimacy threshold is a preset intimacy level matching condition. If the intimacy level is greater than or equal to the intimacy threshold, the information about the virtual equipment currently worn by the second virtual character cannot be displayed through the information display area. If the intimacy level is greater than or equal to the intimacy threshold, the equipment outfit display sub-area including the information about the virtual equipment currently worn by the second virtual character is displayed in the information display area.

In some embodiments, the intimacy level between the first account and the account corresponding to the second virtual character is in a positive correlation with the number of interactions through the interaction mode. The interaction mode includes at least one of interaction forms such as chatting, liking, commenting, and team forming, which is not limited in this embodiment of the present disclosure.

Illustratively, by setting an intimacy threshold to limit the display of the virtual equipment information, only when an interaction frequency between the first account and another account is high (with a high number of interactions), virtual equipment information of a virtual character corresponding to the another account will be displayed.

Setting the preset interaction condition can limit, to some extent, the first account from viewing the virtual equipment information, thereby helping encourage the first account to participate in a game process more actively, and also reducing, to some extent, a data processing burden of rendering the virtual equipment information by the terminal, and thus making a game content more layered and enriched. Using the intimacy level reaching the intimacy threshold as the preset interaction condition further helps encourage the first account and the second account to friendly interact in the game, which not only reduces a burden on the server to some extent, but also helps improve the interaction frequency between players.

Operation 330: Display equipment acquisition information corresponding to the first equipment in response to receiving a trigger operation on the first equipment in the information display area.

In some embodiments, the foregoing trigger operation includes at least one of a click/tap operation, a long-press operation, a swipe operation, a voice instruction operation, a gesture instruction operation, or the like, which is not limited in this embodiment of the present disclosure.

Illustratively, the equipment acquisition information is information related to equipment acquisition, and the equipment acquisition information corresponding to the first equipment is configured for representing information related to acquiring the first equipment. Illustratively, the equipment acquisition information of the first equipment includes at least one of multiple pieces of information such as the number of redemption resources needed for acquiring the first equipment (e.g., using 10 virtual gold coins for redeeming the first equipment), a redemption status of the first equipment (e.g., a redeemable status and an irredeemable status), and an acquisition entry for acquiring the first equipment.

In some embodiments, the equipment acquisition information includes an equipment acquisition path. The equipment acquisition path is configured for indicating a mode in which the virtual equipment is acquired, for example, acquisition by way of activity participation, acquisition by way of a resource exchange platform, acquisition by way of giving, or acquisition by way of picking, which is not limited in this embodiment of the present disclosure.

In some embodiments, the information display area includes the equipment outfit display sub-area, and the equipment outfit display sub-area includes an equipment picture of the first equipment.

In some embodiments, the equipment acquisition information corresponding to the first equipment is displayed in response to receiving a trigger operation on the equipment picture of the first equipment in the equipment outfit display sub-area. Illustratively, after clicking/tapping the equipment picture of the first equipment, the equipment acquisition path of the first equipment is displayed. For example, a platform acquiring control is displayed to prompt acquisition through the resource exchange platform.

By using the equipment picture to vividly indicate the first equipment, the equipment acquisition information of the first equipment may be displayed by clicking/tapping the equipment picture, and the player previews a general situation of the equipment more quickly through the equipment picture. In addition, the player performs a triggering process on the equipment picture, such that the process of displaying the equipment acquisition information is more efficient, thereby helping the player quickly learn of the equipment acquisition information of the first equipment, and improving the efficiency of acquiring the virtual equipment by the player. When the first equipment meets an equipment acquisition condition, the equipment acquisition information includes the acquisition entry of the first equipment.

In some embodiments, the equipment acquisition condition is a preset condition for redeeming the first equipment. The first equipment meeting the equipment acquisition condition means that the first equipment is equipment that is allowed to be redeemed in a current application program. Illustratively, the first equipment is a redeemable item provided in the resource exchange platform (e.g., a mall) in the application program, and the player may redeem the first equipment in the resource exchange platform by using a virtual resource (e.g., points, gold coins, or diamonds).

In some embodiments, an equipment detail area corresponding to the first equipment is displayed in response to receiving a trigger operation on the first equipment in the equipment outfit display sub-area, where the equipment detail area includes equipment acquisition information corresponding to the first equipment.

Illustratively, the equipment detail area is an area configured for displaying various equipment information related to the first equipment. For example, the equipment detail area corresponding to the first equipment includes at least one of a plurality of types of information such as equipment attribute information (e.g., an equipment level and an equipment size), equipment effective duration information (e.g., effective within 10 minutes), and equipment acquisition information of the first equipment.

In some embodiments, the equipment detail area includes the equipment acquisition path and the acquisition entry in response to the first equipment meeting the equipment acquisition condition; a trigger operation on the acquisition entry of the first equipment is received; and the equipment detail area is displayed in response to the trigger operation.

In some embodiments, the equipment acquisition condition includes at least one of the following conditions:

Condition I: When the first equipment is acquired through the resource exchange platform and the first equipment meets the equipment acquisition condition, the first acquisition path and the first acquisition entry are displayed as the equipment acquisition information corresponding to the first equipment.

The first acquisition path indicates that the first equipment is acquired through the resource exchange platform. Illustratively, the first acquisition path is represented by a platform identifier. The platform identifier is configured for uniquely indicating the resource exchange platform, such as a full name, a short name, an abbreviation, or a flag identifier of the resource exchange platform.

The first acquisition entry is configured for redeeming the first equipment on the resource exchange platform. Illustratively, the first acquisition entry is a redemption control configured to redeem the first equipment; or, the first acquisition entry is a redemption link or the like for redeeming the first equipment.

In some embodiments, the resource exchange platform is displayed in response to receiving the trigger operation on the first acquisition entry, the resource exchange platform being configured to redeem the first equipment through the virtual resource.

Illustratively, the first acquisition path is displayed in the equipment detail area, namely, displaying that the first equipment is acquired through the resource exchange platform. The first acquisition entry is further displayed in the equipment detail area. After the first acquisition entry is clicked/tapped, the resource exchange platform is displayed. The resource exchange platform includes multiple pieces of redeemable virtual equipment, where the first equipment is selected equipment. Or, after the first acquisition entry is clicked/tapped, the resource exchange platform is displayed, the resource exchange platform being a resource exchange page corresponding to the first equipment.

When the first equipment is redeemed through the resource exchange platform, if the first equipment meets the equipment acquisition condition, the first acquisition entry of the resource exchange platform may be displayed as a trigger entry, such that the player can quickly jump, through the first acquisition entry, to the resource exchange platform to redeem the first equipment, thereby shortening an equipment redemption process, and improving the efficiency of acquiring the virtual equipment.

Condition II: When the first equipment is acquired through participation in a game activity, and a current moment is within an activity deadline range of the game activity, and the first equipment meets the equipment acquisition condition, the second acquisition path and the second acquisition entry are acquired as the equipment acquisition information corresponding to the first equipment.

The second acquisition path indicates that the first equipment is acquired through participation in the game activity, the second acquisition entry is configured for participating in the game activity, and the activity deadline range is configured for indicating a duration time period of the game activity.

Illustratively, the second acquisition path is an activity identifier corresponding to the game activity, such as an activity icon of the game activity, or an activity deadline range of the game activity. The second acquisition entry is an activity redirection link corresponding to the game activity, or the second acquisition entry is an activity participation control corresponding to the game activity, or the like.

In some embodiments, an activity participation platform is displayed in response to receiving a trigger operation on the second acquisition entry, the activity participation platform being configured for participating in the game activity; and the first equipment is acquired when participation in the game activity meets an activity equipment acquisition condition.

The activity equipment acquisition condition is a condition for acquiring the first equipment through the game activity. Illustratively, the activity equipment acquisition condition is that activity points in a game activity reach preset points; or, the activity equipment acquisition condition is that a survival duration in a game activity reaches a preset duration; or, the activity equipment acquisition condition is searching for the first equipment in a game activity. The activity equipment acquisition condition is not limited herein.

Illustratively, the game activity refers to an activity provided in the application program, such as a point challenging event or a treasure hunting activity, which is not limited in this embodiment of the present disclosure. The second acquisition path is displayed in the equipment detail area, namely, displaying that the first equipment is acquired through participation in the game activity. The second acquisition entry is further displayed in the equipment detail area. After the player clicks/taps the second acquisition entry of the first equipment, the activity participation platform is displayed. The player may participate in the game activity through the activity participation platform. After participating in the game activity and meeting the activity equipment acquisition condition, the player may acquire the first equipment.

When the first equipment is acquired through participation in the activity, if the current moment is still within the activity deadline range corresponding to the game activity and the first equipment meets the equipment acquisition condition, the second acquisition entry of the activity participation platform is displayed as the trigger entry, such that the player can quickly jump, through the second acquisition entry, to the activity participation platform to participate in the game activity to strive for acquiring the first equipment, thereby expanding a promotion mode of the game activity, promoting more players to participate in the game activity, and also improving the efficiency of acquiring the virtual equipment.

The foregoing descriptions of the equipment acquisition condition are merely illustrative examples, and are not limited in this embodiment of the present disclosure.

In some other embodiments, equipment acquisition information of virtual equipment currently worn by the second virtual character is displayed in response to receiving a trigger operation on the character image of the second virtual character. Illustratively, after the second virtual character is clicked/tapped, the equipment acquisition information of the virtual equipment currently worn by the second virtual character is directly displayed. The trigger operation herein and the trigger operation in operation 320 may be implemented as different trigger operations. For example, after the character image of the second virtual character is clicked/tapped, the information display area is displayed. After the character image of the second virtual character is long-pressed, the equipment acquisition information is displayed.

In some other embodiments, in a case of determining that the first equipment meets the equipment acquisition condition, an equipment acquisition area corresponding to the first equipment is displayed in response to receiving the trigger operation on the first equipment in the equipment outfit display sub-area. Illustratively, if the first equipment meets the equipment acquisition condition, after clicking/tapping the first equipment, the display directly jumps to the equipment acquisition area.

In some other embodiments, when the first equipment does not meet the equipment acquisition condition, the equipment acquisition information does not include the acquisition entry of the first equipment.

In some embodiments, the first equipment not meeting the equipment acquisition condition means that the first equipment is equipment in the current application program that is not allowed to be redeemed. Illustratively, when the first equipment is acquired through the game activity, and the current moment is outside the activity deadline range corresponding to the game activity, it is determined that the first equipment does not meet the equipment acquisition condition, and the equipment detail area includes the equipment acquisition path. That is, the equipment detail area displays that the first equipment is acquired through participation in the game activity, but does not display the foregoing acquisition entry.

In some embodiments, the first equipment not meeting the equipment acquisition condition means that the first equipment is equipment owned by the first account. Illustratively, when the first equipment is equipment owned by the first account, it is determined that the first equipment does not meet the equipment acquisition condition, and the equipment detail area includes the equipment acquisition path. That is, the equipment detail area displays that the first equipment is acquired through participation in the game activity, but does not display the foregoing acquisition entry. The equipment detail area further includes the second marking information, and the second marking information is configured for indicating that the first account owns the first equipment.

In some embodiments, when the first virtual character meets a wearing condition corresponding to the first equipment, the equipment acquisition information further includes a wearing entry, and the wearing entry is configured for controlling the first virtual character to wear the first equipment.

In some embodiments, when the first account owns the first equipment, and the first virtual character does not currently wear the first equipment, it is determined that the first virtual character meets the wearing condition corresponding to the first equipment.

In some embodiments, when the first account owns the first equipment and the first virtual character does not currently wear the first equipment, the equipment acquisition path and the wearing entry are displayed as the equipment acquisition information corresponding to the first equipment.

The equipment acquisition path is configured for indicating a mode of acquiring the first equipment, and the wearing entry is configured for controlling the first virtual character to wear the first equipment. Illustratively, the equipment acquisition path is configured for indicating a mode of acquiring the virtual equipment, for example, acquisition by way of activity participation, acquisition by way of the resource exchange platform, acquisition by way of giving, or acquisition by way of picking. That is, when the first virtual character meets the wearing condition corresponding to the first equipment, the equipment acquisition information not only may include the foregoing wearing entry, but also may include the equipment acquisition path, so as to remind the player of the mode of previously acquiring the first equipment, and enhance information richness.

In some embodiments, a wearing animation is displayed in response to receiving a trigger operation on the wearing entry, the wearing animation referring to an animation in which the first virtual character wears the first equipment.

In some embodiments, a method for displaying the wearing animation further includes: displaying an equipment wearing platform in response to receiving the trigger operation on the wearing entry, the equipment wearing platform being configured for controlling the first virtual character to wear the virtual equipment owned by the first account; and displaying the wearing animation in response to receiving a wearing operation on the first equipment on the equipment wearing platform.

In the foregoing embodiment, when the player owns the first equipment, if the virtual character controlled by the player does not wear the equipment at this time, an entry for the player to quickly wear the first equipment is provided, such that the player can quickly wear the equipment when seeing the equipment that the player owns but does not wear, thereby improving the human-computer interaction efficiency and also improving the equipment acquisition efficiency.

In some embodiments, the foregoing equipment detail area further includes equipment details of the first equipment, namely detailed introduction information about the virtual equipment. In some embodiments, the equipment details include an equipment display picture, an equipment name, and the like. Illustratively, assuming that an equipment picture corresponding to the first equipment is displayed in the equipment outfit display sub-area, after the equipment picture is clicked/tapped, the equipment detail area is displayed, and an equipment display picture and an equipment name corresponding to the first equipment are displayed in the equipment detail area. Alternatively, the equipment name corresponding to the first equipment is displayed in the equipment outfit display sub-area. After the equipment name is clicked/tapped, the equipment detail area is displayed, and the equipment display picture and the equipment name corresponding to the first equipment are displayed in the equipment detail area.

In some embodiments, the equipment picture may be implemented as a small-size first equipment display image, and the equipment display picture may be implemented as a large-size first equipment display image.

In some other embodiments, the equipment outfit display sub-area includes type icons corresponding to different types of virtual equipment. Illustratively, assuming that the types of the virtual equipment include virtual clothing, a virtual vehicle, a virtual prop, and the like, the type icons include a type icon corresponding to the type of the virtual clothing, a type icon corresponding to the type of the virtual vehicle, a type icon corresponding to the type of the virtual prop, and the like. Assuming that the virtual equipment is implemented as the virtual clothing, and types of the virtual clothing include virtual clothes, virtual pants, virtual shoes, and the like, the type icon is a type icon corresponding to the type of the virtual clothes, a type icon corresponding to the type of the virtual pants, a type icon corresponding to the type of the virtual shoes, or the like.

In some embodiments, an equipment list corresponding to the first type is displayed in response to receiving a trigger operation on an icon of the first type in the equipment outfit display sub-area, the equipment list being configured for displaying virtual equipment of the first type; and equipment acquisition information corresponding to the first equipment is displayed in response to receiving a trigger operation on the first equipment in the equipment list.

Illustratively, assuming that the first equipment is a coat worn by the second virtual character, and there are a plurality of upper garments worn by the second virtual character (e.g., an undershirt, a coat, and a trench coat), a type icon for one clothing type may be first displayed in the equipment outfit display sub-area. After the type icon is clicked/tapped, icons of all the upper garments worn by the second virtual character are displayed, including the icon for the coat worn by the second virtual character. By clicking/tapping the icon corresponding to the coat, the equipment acquisition information corresponding to the coat is displayed.

In this manner, after receiving a trigger operation on the second virtual character corresponding to the another computer device in the virtual scene, information about virtual equipment or virtual equipment information currently worn by another virtual character is displayed in the information display area corresponding to the virtual character, such that the player can quickly view a virtual equipment status of the another virtual character, without the need to additionally open the another entry to learn of the virtual equipment status, thereby improving the human-computer interaction efficiency. In addition, after receiving the trigger operation on the first equipment in the information display area, the equipment acquisition information corresponding to the first equipment may be displayed, such that the player can conveniently learn of the acquisition path of the virtual equipment worn by the another virtual character. In addition, when the first equipment meets the equipment acquisition condition, the equipment acquisition information includes the acquisition entry of the first equipment, which provides the entry for the player to rapidly acquire the first equipment, thereby reducing operations of acquiring the equipment, and improving the efficiency of acquiring the virtual equipment.

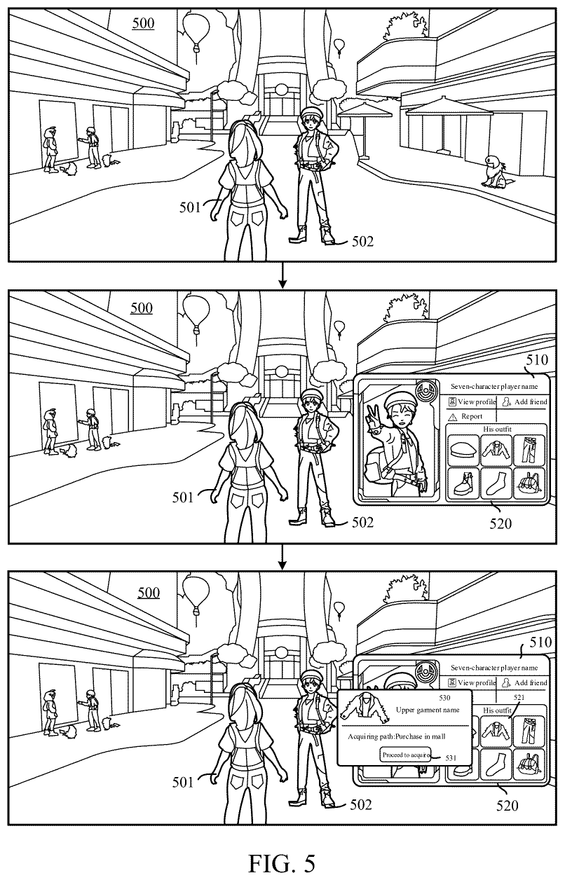

Illustratively, an example in which the virtual equipment is implemented as a virtual clothing is used for description. Referring to FIG. 5, FIG. 5 is a schematic diagram of an interface of a method for acquiring a virtual clothing. As shown in FIG. 5, in a virtual scene 500, a player controls the first virtual character 501 to move. When the player sees the second virtual character 502, if the player is interested in an outfit of the second virtual character 502 and wants to acquire the same outfit, the player may click/tap the second virtual character 502.

After the second virtual character 502 is clicked/tapped, a character detail pop-up window 510 appears. In addition to basic interaction functions such as viewing personal profiles and adding friends, an outfit display area 520 in the character detail pop-up window 510 displays details of the outfit (including clothes, a hat, pants, shoes and socks, accessories, etc.) currently worn by the second virtual character 502.

By clicking/tapping an individual item clothing icon 521 within the outfit display area 520, detailed information about a clothing may be further viewed. The detailed information 530 about the clothing includes a clothing name and an acquisition path. The acquisition path “Redeemable through the mall” indicates that the clothing is a clothing that is allowed to be redeemed in an application program, and the clothing meets an equipment acquisition condition. The detailed information 530 about the clothing further includes a “Proceed to acquire” button 531, and the clothing can be quickly acquired by clicking/tapping the “Proceed to acquire” button 531.

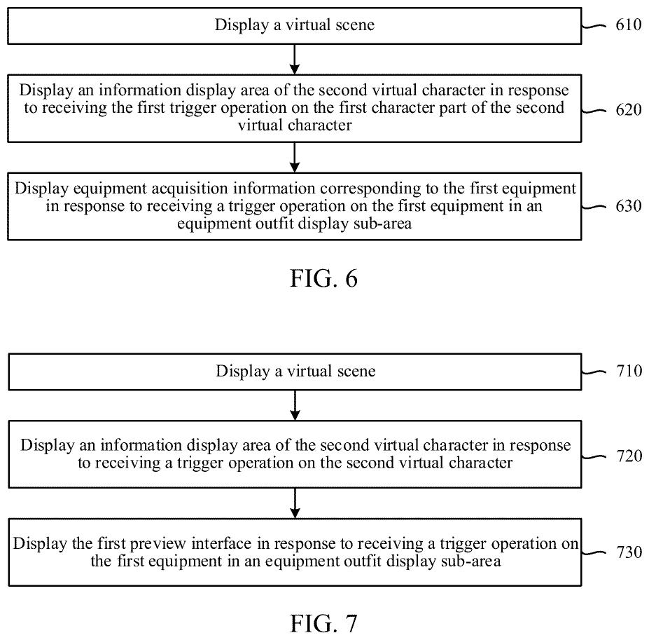

In some embodiments, the first equipment is equipment worn by the first character part of the second virtual character, and information about the virtual equipment currently worn by the first character part of the second virtual character may be displayed through a trigger operation on the first character part. Illustratively, as shown in FIG. 6, the embodiment shown in FIG. 3 may also be implemented as operation 610 to operation 630 described below.

Operation 610: Display a virtual scene.

The virtual scene includes the first virtual character and the second virtual character, the first virtual character is a virtual character controlled by a current computer device, and the second virtual character is a virtual character controlled by another computer device. For example, the first account is logged in on the current computer device, and the first account corresponds to an operation of the first virtual character. The second account is logged in on the another computer device, and the second account corresponds to an operation of the second virtual character.

In some embodiments, the virtual character includes a plurality of character parts, and the character parts include a virtual head, a virtual upper body part, virtual hands, a virtual lower body part, virtual feet, and the like.

In some embodiments, different virtual equipment is worn by different character parts of the virtual character. For example, wearable virtual equipment on the virtual head includes a helmet, a hat, glasses, earrings, and the like. The wearable virtual equipment on the virtual upper body part includes an upper garment, a packsack, and the like. The wearable virtual equipment on the virtual hands includes a glove, a ring, and the like. The wearable virtual equipment on the virtual lower body part includes pants, a belt, and the like. The wearable virtual equipment on the virtual feet includes shoes, socks, and the like.

Operation 620: Display an information display area of the second virtual character in response to receiving the first trigger operation on the first character part of the second virtual character.

In some embodiments, the information display area includes character information of the second virtual character and an interaction function button.

The information display area includes an equipment outfit display sub-area, and the equipment outfit display sub-area is configured for displaying information about the virtual equipment currently worn by the first character part of the second virtual character.

Illustratively, assuming that the first character part is the head of the second virtual character, after the head of the second virtual character is clicked/tapped, the equipment outfit display sub-area in the information display area displays information about virtual equipment (i.e., the first equipment) currently worn by the head of the second virtual character, such as a hat or glasses.

In some embodiments, the quantity of the first equipment may be one or more.

The foregoing operation 610 to operation 620 describe the display of the content of the information display area based on the first trigger operation on the first character part. The first character part is a character part triggered on the second virtual character. The information about the virtual equipment currently worn by the first character part may be displayed in a targeted mode through the first trigger operation, thereby improving a display granularity of the virtual equipment information, facilitating more efficient positioning of the virtual equipment worn by the character part, and improving the human-computer interaction efficiency.

Operation 630: Display equipment acquisition information corresponding to the first equipment in response to receiving a trigger operation on the first equipment in an equipment outfit display sub-area.

Illustratively, the equipment outfit display sub-area includes an equipment picture of the first equipment. After clicking/tapping the equipment picture of the first equipment, an equipment acquisition path of the first equipment is displayed, such as acquisition by way of a resource exchange platform. When the first equipment meets an equipment acquisition condition, the equipment acquisition information includes an acquisition entry of the first equipment.

In some embodiments, the first equipment meeting the equipment acquisition condition means that the first equipment is equipment that is allowed to be redeemed in a current application program. Illustratively, the first equipment is a redeemable item provided in the resource exchange platform (e.g., a mall) in the application program, and the player may redeem the first equipment in the resource exchange platform by using a virtual resource (e.g., points, gold coins, or diamonds).

In some other embodiments, after clicking/tapping the first character part, the equipment acquisition information corresponding to the first equipment may be directly displayed.

In some embodiments, the equipment acquisition information corresponding to the first equipment is displayed in response to the second trigger operation on the first character part of the second virtual character. The first trigger operation and the second trigger operation described above are different. For example, the first trigger operation is a click/tap operation, and the second trigger operation is a long-press operation.

The first character part wears the first equipment. Illustratively, after the player sees an equipment wearing status of the second virtual character, if the player is interested in the first equipment in multiple pieces of virtual equipment worn by the second virtual character, the player may long press the first character part of the second virtual character wearing the first equipment, thereby displaying equipment acquisition information corresponding to the first equipment.

The foregoing content describes the content of displaying the equipment acquisition information based on the second trigger operation on the first character part wearing the first equipment. If the player is interested in the first equipment when the second virtual character wears the multiple pieces of virtual equipment, the player may quickly perform a trigger operation on the first equipment in advance through a mode of directly triggering the first character part wearing the first equipment, thereby displaying the equipment acquisition information of the first equipment on the interface in a targeted mode, simplifying an information acquiring process, and improving the display efficiency of the equipment acquisition information.

In some other embodiments, when the first equipment meets the equipment acquisition condition, after the first character part is triggered, an equipment acquisition area corresponding to the first equipment may be directly displayed.

In some embodiments, in response to receiving the second trigger operation on the first character part of the second virtual character, the equipment acquisition area corresponding to the first equipment is displayed when the first equipment meets the equipment acquisition condition.

When the first equipment is acquired through the resource exchange platform, the equipment acquisition area is the resource exchange platform. When the first equipment is acquired through participation in a game activity, and a current moment falls within an activity deadline range corresponding to the game activity, the equipment acquisition area is the resource exchange platform.

In this manner, after receiving a trigger operation on the second virtual character corresponding to the another computer device in the virtual scene, information about virtual equipment currently worn by another virtual character is displayed in the information display area corresponding to the virtual character, such that the player can quickly view a virtual equipment status of the another virtual character, without the need to additionally open another entry to learn of the virtual equipment status, thereby improving the human-computer interaction efficiency. In addition, after receiving the trigger operation on the first equipment in the information display area, the equipment acquisition information corresponding to the first equipment may be displayed, such that the player can conveniently learn of the acquisition path of the virtual equipment worn by the another virtual character. In addition, when the first equipment meets the equipment acquisition condition, the equipment acquisition information includes the acquisition entry of the first equipment, which provides the entry for the player to rapidly acquire the first equipment, thereby reducing operations of acquiring the equipment, and improving the efficiency of acquiring the virtual equipment.

According to the method provided in this embodiment of the present disclosure, after a trigger operation on a character part of a virtual character corresponding to another account in the virtual scene is received, the equipment acquisition information corresponding to the first equipment worn by the character part is directly displayed, thereby reducing operations of displaying the equipment acquisition information, improving the efficiency of acquiring the virtual equipment, and also saving display resources.

In some embodiments, after the foregoing first equipment is clicked/tapped, a preview interface may be displayed to preview an effect that the first virtual character wears the first equipment. Illustratively, as shown in FIG. 7, the embodiment shown in FIG. 3 or FIG. 6 may also be implemented as operation 710 to operation 730 described below.

Operation 710: Display a virtual scene.

The virtual scene includes the first virtual character and the second virtual character, the first virtual character is a virtual character controlled by a computer device, and the second virtual character is a virtual character controlled by another computer device.

In some embodiments, both the first virtual character and the second virtual character wear virtual equipment.

Operation 720: Display an information display area of the second virtual character in response to receiving a trigger operation on the second virtual character.

Illustratively, the foregoing virtual scene may be implemented as a scene of a “main city” in a game. When a player sees another virtual character (i.e., the second virtual character) in the “main city”, the player may click/tap a character image of the virtual character, and the information display area corresponding to the virtual character may be displayed after the click/tap. The information display area includes an equipment outfit display sub-area, and the equipment outfit display sub-area includes information about virtual equipment currently worn by the second virtual character.

In some embodiments, the equipment outfit display sub-area includes the first equipment currently worn by the second virtual character.

Operation 730: Display the first preview interface in response to receiving a trigger operation on the first equipment in an equipment outfit display sub-area.

The foregoing first preview interface includes equipment acquisition information corresponding to the first equipment, and the first preview interface is configured for previewing an effect that the first virtual character wears the first equipment.

Illustratively, after the first equipment is clicked/tapped, one preview interface may be displayed, the preview interface includes a preview area and an information area, the preview area is configured for previewing a dressing effect of the virtual equipment, and the information area is configured for displaying equipment information and/or equipment acquisition information about the virtual equipment. Illustratively, the effect that the first virtual character wears the first equipment is displayed through the preview area in the preview interface, and meanwhile the equipment acquisition information corresponding to the first equipment is displayed in the information area of the preview interface. When the first equipment meets an equipment acquisition condition, the equipment acquisition information includes an acquisition entry of the first equipment. Therefore, after previewing the effect that the first virtual character wears the first equipment, the player may acquire the first equipment through the acquisition entry.

In some embodiments, the first equipment is equipment worn by the first character part, and when the information display area of the second virtual character is displayed in response to receiving the first trigger operation on the first character part of the second virtual character, the first preview interface is displayed in response to receiving the first trigger operation on the first character part of the second virtual character. Illustratively, after the first character part is clicked/tapped, the first preview interface may be directly displayed.

In some other embodiments, the second preview interface is displayed in response to receiving a trigger operation on a character image of the second virtual character, the second preview interface being configured for previewing an effect that the first virtual character wears virtual equipment currently worn by the second virtual character, the second preview interface including an equipment outfit display sub-area, and the equipment outfit display sub-area including information about the virtual equipment currently worn by the second virtual character; and an effect that the first virtual character wears the first equipment is displayed in the preview area of the second preview interface in response to receiving the trigger operation on the first equipment in the equipment outfit display sub-area, and the equipment acquisition information of the first equipment is displayed in the information area of the second preview interface.

In some embodiments, the equipment outfit display sub-area includes multiple pieces of equipment. In response to receiving a selection operation on the third equipment in the equipment outfit display sub-area, an effect that the first virtual character wears the third equipment is displayed.

In some embodiments, in response to receiving the selection operation on the third equipment in the equipment outfit display sub-area, the effect that the first virtual character wears the third equipment is displayed in the preview area, and equipment acquisition information corresponding to the third equipment is displayed in the information area.

In some embodiments, when there is no conflict between the first virtual character wearing the first equipment and the first virtual character wearing the third equipment, in response to receiving the selection operation on the third equipment in the equipment outfit display sub-area, effects that the first virtual character wears the first equipment and the third equipment are simultaneously displayed.

Illustratively, a case that there is no conflict between the first virtual character wearing the first equipment and the first virtual character wearing the third equipment may be: the first equipment being a clothing, and the third equipment being pants; the first equipment being a coat, and the third equipment being an undershirt; and the first equipment being a hat, and the third equipment being glasses. When the first virtual character wears the first equipment and the third equipment without conflicts, after the third equipment is selected, the effects that the first virtual character wears the first equipment and the third equipment may be simultaneously displayed.

In some embodiments, when the first virtual character wears the first equipment and the third equipment with conflicts, an equipment switching animation is displayed in response to receiving the selection operation on the third equipment in the equipment outfit display sub-area. The equipment switching animation refers to an animation of switching the first equipment worn by the first virtual character to the third equipment.

Illustratively, a case that the first virtual character wears the first equipment and the third equipment with conflicts may be: the first equipment and the third equipment being coats of different styles. When the first virtual character wears the first equipment, if the third equipment is selected, the equipment switching animation of switching the first equipment to the third equipment is displayed, thereby displaying an animation effect that the first virtual character wears the third equipment.

In some embodiments, in response to receiving the selection operation on the third equipment in the equipment outfit display sub-area, equipment acquisition information corresponding to the first equipment and the third equipment is simultaneously displayed in the information area; or, only the equipment acquisition information corresponding to the third equipment is displayed in the information area.

In this manner, after receiving a trigger operation on the second virtual character corresponding to the another computer device in the virtual scene, information about virtual equipment currently worn by another virtual character is displayed in the information display area corresponding to the virtual character, such that the player can quickly view a virtual equipment status of the another virtual character, without the need to additionally open another entry to learn of the virtual equipment status, thereby improving the human-computer interaction efficiency. In addition, after receiving the trigger operation on the first equipment in the information display area, the equipment acquisition information corresponding to the first equipment may be displayed, such that the player can conveniently learn of an acquisition path of the virtual equipment worn by the another virtual character. In addition, when the first equipment meets the equipment acquisition condition, the equipment acquisition information includes the acquisition entry of the first equipment, which provides the entry for the player to rapidly acquire the first equipment, thereby reducing operations of acquiring the equipment, and improving the efficiency of acquiring the virtual equipment.

In the method provided in this embodiment of the present disclosure, after receiving the trigger operation on the first equipment in the equipment outfit display sub-area, the first preview interface corresponding to the first equipment may be displayed, and the equipment acquisition information is displayed on the first preview interface, such that the player can preview the wearing effect of the first equipment through the first preview interface while conveniently learning of the acquisition path of the virtual equipment worn by the another virtual character, thereby improving the richness of information display. In addition, when the first equipment meets the equipment acquisition condition, the equipment acquisition information includes the acquisition entry of the first equipment, which provides the entry for the player to rapidly acquire the first equipment, thereby reducing operations of acquiring the equipment, and improving the efficiency of acquiring the virtual equipment.

In the method provided in this embodiment of the present disclosure, after receiving the trigger operation on the character image of the second virtual character, the second preview interface may be displayed, and the equipment outfit display sub-area is displayed on the second preview interface. The information about the virtual equipment currently worn by the second virtual character may be displayed through the equipment outfit display sub-area, such that the player can quickly view the virtual equipment status of the another virtual character, thereby preventing the player from additionally opening another entry to learn of the virtual equipment status. In addition, the player may preview, through the second preview interface, the effect of wearing the virtual equipment of the second virtual character, thereby improving the human-computer interaction efficiency.

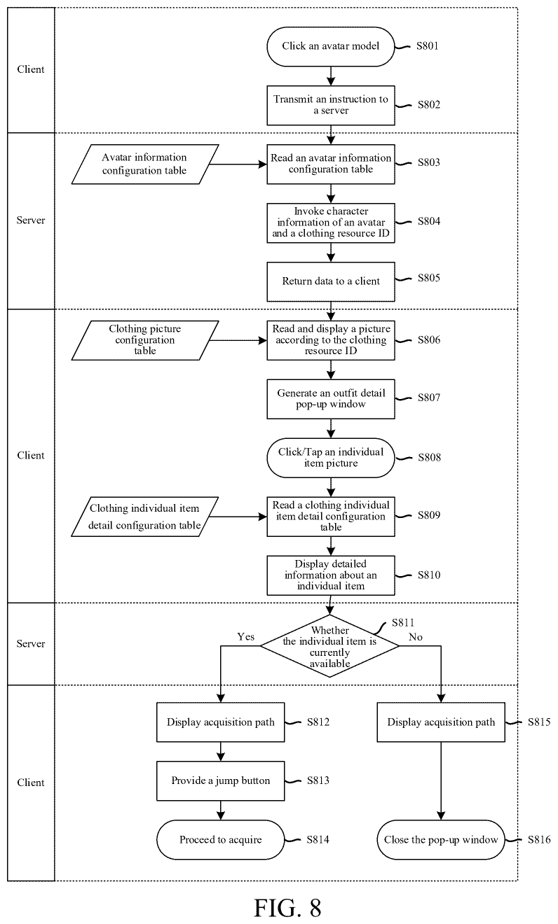

Illustratively, an example in which the virtual equipment is implemented as a virtual clothing is used for description. Referring to FIG. 8, FIG. 8 is a client-server interaction flowchart of a method for acquiring virtual equipment. FIG. 8 includes the following operations.

S801: A client clicks/taps an avatar model.

Illustratively, the client is a client of a game, and the game may be any one of a virtual reality application, a TPS game, an FPS game, a multiplayer online battle arena game, a massive multiplayer online role-playing game, a turn-based action game, or the like.

The first account is logged in on the client of the game, and the first virtual character corresponding to the first account and the second virtual character corresponding to another account are displayed in a virtual scene provided by the client of the game.

Illustratively, the foregoing virtual characters (including the first virtual character and the second virtual character) are implemented as virtual avatar characters. The avatar characters refer to characters obtained through rendering by using an avatar model. The avatar model is a virtual image model based on computer generation and an animation technology, and is a graphical representation of a player in the virtual scene. The avatar model allows the player to perform customized design, that is, the player can dress up the avatar character of the player through various virtual equipment.

Illustratively, if the player sees an outfit of the second virtual character and is interested in the outfit in the virtual scene provided by the client, the player may click/tap the second virtual character, that is, a click/tap operation on the avatar model corresponding to the second virtual character is received on the client where the first account is logged in.

S802: The client transmits an instruction to a server.

Illustratively, the foregoing click/tap operation is received on the client where the first account is logged in, the client transmits the instruction to the server, and the instruction is configured for instructing to display current outfit details of the second virtual character on the client.

S803: The server reads an avatar information configuration table.

Illustratively, after receiving the instruction transmitted by the client, the server reads an avatar information configuration table. The avatar information configuration table is an information configuration table corresponding to the second virtual character.

S804: The server invokes character information of an avatar and a clothing resource identification (ID).

Illustratively, the server invokes the character information of the avatar from the avatar information configuration table and the clothing resource ID currently bound to the character information of the avatar. The character information of the avatar includes an account name, an account level, an account avatar, and the like of an account corresponding to the second virtual character. The clothing resource ID is a resource ID corresponding to a virtual clothing currently worn by the second virtual character.

S805: The server returns data to the client.

Illustratively, after acquiring the character information of the avatar and the clothing resource ID, the server returns the character information of the avatar and the clothing resource ID to the client.

S806: The client reads and displays a picture according to the clothing resource ID.

Illustratively, after receiving the foregoing character information of the avatar and the clothing resource ID, the client reads a clothing picture configuration table, and reads a corresponding clothing picture from the clothing picture configuration table according to the clothing resource ID.

S807: The client generates an outfit detail pop-up window.

Illustratively, the client generates the outfit detail pop-up window according to the character information of the avatar and the clothing picture, and the outfit detail pop-up window displays the character information of the avatar and specific pictures of the current second virtual character wearing each clothing individual item.

S808: The client clicks/taps an individual item picture.

Illustratively, the player may click/tap the individual item picture in the outfit detail pop-up window to view more information, that is, a click/tap operation on the individual item picture is received on the client where the first account is logged in.

S809: The client reads a clothing individual item detail configuration table.

Illustratively, after receiving the click/tap operation on the individual item picture, the client reads the clothing individual item detail configuration table, and detailed information of the clothing resource are configured in the clothing individual item detail configuration table

S810: The client displays detailed information about an individual item.

Illustratively, the client may display, according to a reading result, the individual item detailed information about the individual item clicked/tapped by the player in the pop-up window.

S811: The server determines whether the individual item is currently available.

Illustratively, when the client reads the clothing individual item detail configuration table, the server may determine whether an individual item resource clicked/tapped by the player is currently available in the game.

S812: The client displays an acquisition path.

Illustratively, if it is determined that the individual item resource clicked/tapped by the player is currently available in the game, the client may display the acquisition path of the individual item resource while displaying the individual item detailed information, such as performing redemption through a resource exchange platform.

S813: The client provides a jump button.

Illustratively, if it is determined that the individual item resource clicked/tapped by the player is currently available in the game, the client may further provide the jump button for the individual item resource, such as displaying a “Proceed to acquire” button, and clicking/tapping the “Proceed to acquire” button will redirect the display to the resource exchange platform.

S814: The client proceeds to acquire.

Illustratively, assuming that the individual item resource may be redeemed and acquired through the resource exchange platform, after the jump button is clicked/tapped, the resource exchange platform is displayed, and the player may redeem the individual item on the resource exchange platform through a virtual resource.

S815: The client displays the acquisition path.

Illustratively, if it is determined that the individual item resource clicked/tapped by the player is currently available in the game, the client may also display the acquisition path of the individual item resource while displaying the individual item detailed information. For example, through game activity redemption, the game activity currently ends.

S816: The client closes the pop-up window.

Illustratively, after viewing the acquisition path of the individual item, the player may close the pop-up window displaying the acquisition path, or close the foregoing outfit detail pop-up window after closing the pop-up window displaying the acquisition path.

The method for acquiring virtual equipment provided in this embodiment of the present disclosure, on one hand, improves an access efficiency of the clothing resource in the game. For the player, compared with a conventional experience path of “seeing a clothing-memorizing a style-going to search-finally acquiring”, the design of this embodiment of the present disclosure can help the player quickly view equipment detailed information of another virtual character through the trigger operation when the player sees an outfit (virtual equipment) of interest, and further provide a quick jump acquiring function, thereby efficiently acquiring game experience of the virtual equipment, greatly shortening the conventional experience path, and enhancing the access efficiency of the clothing resource. On the other hand, the efficiency of acquiring the clothing resource is improved. A fast viewing and jump acquiring function is provided, such that a path from “seeing to acquisition” by the player is greatly shortened, thereby improving the efficiency of acquiring the clothing resource.

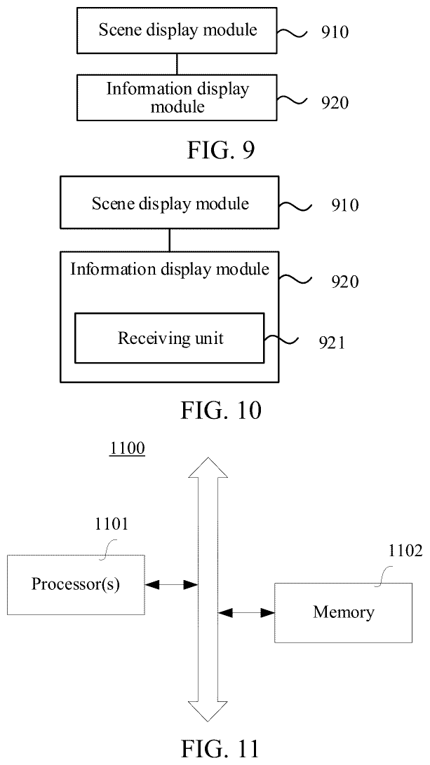

FIG. 9 is a structural block diagram of an apparatus for acquiring virtual equipment according to an exemplary embodiment of the present disclosure. As shown in FIG. 9, the apparatus includes the following parts:
a scene display module 910, configured to display a virtual scene, the virtual scene including the first virtual character and the second virtual character, the first virtual character being a virtual character controlled by a computer device, and the second virtual character being a virtual character controlled by another computer device; and
an information display module 920, configured to display an information display area of the second virtual character in response to receiving a trigger operation on a character image of the second virtual character, the information display area including information about virtual equipment currently worn by the second virtual character,
the information display module 920 being further configured to display equipment acquisition information corresponding to the first equipment in response to receiving a trigger operation on the first equipment in the information display area, and the equipment acquisition information including an acquisition entry of the first equipment when the first equipment meets an equipment acquisition condition.

As shown in FIG. 10, in some embodiments, the information display area includes an equipment outfit display sub-area, and the equipment outfit display sub-area includes an equipment picture of virtual equipment currently worn by the second virtual character. The information display module 920 is configured to display the equipment acquisition information corresponding to the first equipment in response to receiving a trigger operation on the equipment picture of the first equipment in the equipment outfit display sub-area.

In some embodiments, the second virtual character currently wears multiple pieces of virtual equipment; the multiple pieces of virtual equipment are separately displayed in the equipment outfit display sub-area individually; or, the multiple pieces of virtual equipment are displayed in a combined manner with a coordinated form in the equipment dressing display sub-region.

In some embodiments, the first account is logged in on the computer device, and the information display area includes the second equipment currently worn by the second virtual character, where when the first account owns the second equipment, the information display area further includes the first marking information, and the first marking information is configured for indicating that the first account owns the second equipment.

In some embodiments, the information display module 920 includes:
a receiving unit 921, configured to receive a trigger operation on the character image of the second virtual character when a distance between the first virtual character and the second virtual character is less than or equal to a preset distance.

The information display module 920 is configured to display the information display area in response to the trigger operation on the character image of the second virtual character.

In some embodiments, the information display module 920 is further configured to display the information about the virtual equipment currently worn by the second virtual character in the information display area when an intimacy level between the first account logged in on the computer device and another account logged in on another computer device is greater than or equal to an intimacy threshold.

In some embodiments, the information display module 920 is configured to display the first acquisition path and the first acquisition entry as the equipment acquisition information corresponding to the first equipment when the first equipment is acquired through a resource exchange platform and the first equipment meets the equipment acquisition condition, the first acquisition path indicating that the first equipment is acquired through the resource exchange platform, and the first acquisition entry being configured for redeeming the first equipment on the resource exchange platform.

The information display module 920 is further configured to display the resource exchange platform in response to receiving a trigger operation on the first acquisition entry, the resource exchange platform being configured for redeeming the first equipment through a virtual resource.

In some embodiments, the information display module 920 is configured to display the second acquisition path and the second acquisition entry as the equipment acquisition information corresponding to the first equipment when the first equipment is acquired through participation in a game activity, and a current moment is within an activity deadline range of the game activity, and the first equipment meets the equipment acquisition condition, the second acquisition path indicating that the first equipment is acquired through participation in the game activity, and the second acquisition entry being configured for participating in the game activity. The information display module 920 is configured to display an activity participation platform in response to receiving a trigger operation on the second acquisition entry, the activity participation platform being configured for participating in the game activity; and acquire the first equipment when participation in the game activity meets an activity equipment acquisition condition, the activity equipment acquisition condition being a condition for acquiring the first equipment through the game activity.

In some embodiments, the first equipment is equipment worn by the first character part of the second virtual character. The information display module 920 is configured to display the information display area in response to receiving the first trigger operation on the first character part of the second virtual character, the information display area including an equipment outfit display sub-area, and the equipment outfit display sub-area being configured for displaying information about virtual equipment currently worn by the first character part of the second virtual character.

In some embodiments, the information display module 920 is configured to display the equipment acquisition information corresponding to the first equipment in response to receiving the second trigger operation on the first character part of the second virtual character, the first character part wearing the first equipment, and the first trigger operation being different from the second trigger operation.

In some embodiments, the information display module 920 is configured to display the first preview interface, the first preview interface including the equipment acquisition information corresponding to the first equipment, and the first preview interface being configured for previewing an effect that the first virtual character wears the first equipment.

In some embodiments, the information display module 920 is configured to display the second preview interface in response to receiving the trigger operation on the character image of the second virtual character, the second preview interface including the equipment outfit display sub-area, and the second preview interface being configured for previewing an effect that the first virtual character wears the virtual equipment currently worn by the second virtual character.

In some embodiments, the information display module 920 is configured to display an equipment acquisition path and a wearing entry as the equipment acquisition information corresponding to the first equipment when the first account logged in on the computer device owns the first equipment, and the first virtual character does not currently wear the first equipment, the equipment acquisition path being configured for indicating a mode of acquiring the first equipment, and the wearing entry being configured for controlling the first virtual character to wear the first equipment; and the information display module 920 is configured to display a wearing animation in response to receiving a trigger operation on the wearing entry, the wearing animation referring to an animation the first virtual character wearing the first equipment.

In this manner, after receiving a trigger operation on the virtual character corresponding to another account in the virtual scene, information about virtual equipment currently worn by another virtual character is displayed in the information display area corresponding to the virtual character, such that the player can quickly view a virtual equipment status of the another virtual character, without the need to additionally open another entry to learn of the virtual equipment status, thereby improving the human-computer interaction efficiency. In addition, after receiving the trigger operation on the first equipment in the information display area, the equipment acquisition information corresponding to the first equipment may be displayed, such that the player can conveniently learn of the acquisition path of the virtual equipment worn by the another virtual character. In addition, when the first equipment meets the equipment acquisition condition, the equipment acquisition information includes the acquisition entry of the first equipment, which provides the entry for the player to rapidly acquire the first equipment, thereby reducing operations of acquiring the equipment, and improving the efficiency of acquiring the virtual equipment.

The apparatus for acquiring virtual equipment provided in the foregoing embodiment is illustrated only with an example of division of the foregoing function modules. In practical applications, the foregoing functions may be allocated to and completed by different function modules as needed. That is, an internal structure of the apparatus is divided into different function modules to complete all or some of the functions described above. In addition, the embodiments of the apparatus for acquiring virtual equipment and method for acquiring virtual equipment provided in the foregoing embodiments belong to the same conception. For the specific implementation process, refer to the method embodiments. Details are not described herein again.

FIG. 11 is a structural block diagram of an electronic device 1100 according to an exemplary embodiment of the present disclosure. The electronic device 1100 may be a portable mobile terminal, such as a smartphone, an on-board terminal, a tablet computer, a moving picture experts group audio layer III (MP3) player, a moving picture experts group audio layer IV (MP4) player, a notebook computer, or a desktop computer. The electronic device 1100 may also be referred to as another name such as user equipment, a portable terminal, a laptop terminal, or a desktop terminal.

Generally, the electronic device 1100 includes a processor 1101 and a memory 1102.

The processor 1101 may include one or more processing cores, such as a 4-core processor or an 8-core processor. The processor 1101 may be implemented in at least one hardware form of digital signal processing (DSP), a field-programmable gate array (FPGA), or a programmable logic array (PLA). The memory 1102 may include one or more computer-readable storage media. The computer-readable storage media may be non-transitory. The memory 1102 may further include a high-speed random access memory and a nonvolatile memory, such as one or more disk storage devices or flash storage devices. In some embodiments, a non-transitory computer-readable storage medium in the memory 1102 is configured to store at least one instruction. The at least one instruction is configured to be executed by the processor 1101 to implement the method for acquiring virtual equipment provided in the method embodiments of the present disclosure.

In some embodiments, the electronic device 1100 further includes one or more sensors. The one or more sensors include, but are not limited to, a proximity sensor, a gyroscope sensor, and a pressure sensor.

In some embodiments, the electronic device 1100 further includes other component parts. A person skilled in the art may understand that the structure shown in FIG. 11 constitutes no limitation on the electronic device 1100, and the electronic device may include more or fewer components than those shown in the figure, or some components may be combined, or a different component deployment may be used.

An embodiment of the present disclosure further provides a computer device. The computer device may be implemented as the terminal or the server shown in FIG. 2. The computer device includes a processor and a memory, the memory having at least one instruction, at least one program, a code set, or an instruction set stored therein, and the at least one instruction, the at least one program, the code set, or the instruction set being loaded and executed by the processor to implement the method for acquiring virtual equipment provided in the foregoing method embodiments.

An embodiment of the present disclosure further provides a computer-readable storage medium, having at least one instruction, at least one program, a code set, or an instruction set stored therein, the at least one instruction, the at least one program, the code set, or the instruction set being loaded and executed by a processor to implement the method for acquiring virtual equipment according to the foregoing method embodiments.

An embodiment of the present disclosure further provides a computer program product or a computer program, including computer instructions, the computer instructions being stored in a computer-readable storage medium. A processor of a computer device reads the computer instructions from the computer-readable storage medium, and the processor executes the computer instructions, to cause the computer device to perform the method for acquiring virtual equipment according to any one of the foregoing method embodiments.

As such, the technical solutions provided in the embodiments of the present disclosure produce at least the following beneficial effects. After receiving a trigger operation on the second virtual character corresponding to the another computer device in the virtual scene, information about virtual equipment currently worn by another virtual character is displayed in an information display area corresponding to the virtual character, such that a player can quickly view a virtual equipment status of the another virtual character, without the need to additionally open another entry to learn of the virtual equipment status, thereby improving a human-computer interaction efficiency. In addition, after receiving the trigger operation on the first equipment in the information display area, the equipment acquisition information corresponding to the first equipment may be displayed, such that the player can conveniently learn of an acquisition path of the virtual equipment worn by the another virtual character. In addition, when the first equipment meets the equipment acquisition condition, the equipment acquisition information includes the acquisition entry of the first equipment, which provides the entry for the player to rapidly acquire the first equipment, thereby reducing operations of acquiring the equipment, and improving the efficiency of acquiring the virtual equipment.

In some embodiments, the computer-readable storage medium may include: a read only memory (ROM), a random access memory (RAM), solid state drives (SSDs), an optical disc, or the like. The random access memory may include a resistance random access memory (ReRAM) and a dynamic random access memory (DRAM). The sequence numbers of the foregoing embodiments of the present disclosure are merely for description purpose but do not indicate the preference of the embodiments.

A person skilled in the art may understand that all or some of the operations of the foregoing embodiments may be implemented by hardware, or may be implemented by a program instructing relevant hardware. The program may be stored in a computer-readable storage medium. The above-mentioned storage medium may be a read only memory, a magnetic disk, an optical disc, or the like.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A method for acquiring virtual equipment, performed by a computer device, the method comprising:
displaying a virtual scene, the virtual scene comprising a first virtual character and a second virtual character, the first virtual character being controlled by the computer device, and the second virtual character being controlled by another computer device;
displaying an information display area of the second virtual character in response to receiving a trigger operation on a character image of the second virtual character, the information display area comprising virtual equipment information currently worn by the second virtual character; and
displaying equipment acquisition information corresponding to a first equipment in response to receiving a trigger operation on the first equipment in the information display area, the equipment acquisition information comprising an acquisition entry of the first equipment when the first equipment meets an equipment acquisition condition.

2. The method according to claim 1, wherein the information display area comprises an equipment outfit display sub-area, and the equipment outfit display sub-area comprises an equipment picture of the virtual equipment currently worn by the second virtual character; and
displaying the equipment acquisition information corresponding to the first equipment in response to receiving the trigger operation on the first equipment in the information display area comprises:
displaying the equipment acquisition information corresponding to the first equipment in response to receiving a trigger operation on the equipment picture of the first equipment in the equipment outfit display sub-area.

3. The method according to claim 2, wherein the second virtual character currently wears multiple pieces of virtual equipment;
the multiple pieces of virtual equipment are separately displayed individually in the equipment outfit display sub-area; or
the multiple pieces of virtual equipment are displayed in a combined manner with a coordinated form in the equipment dressing display sub-region.

4. The method according to claim 1, wherein a first account is logged in on the computer device, and the information display area comprises a second equipment currently worn by the second virtual character; and
when the first account owns the second equipment, the information display area further comprises first marking information, and the first marking information is configured for indicating that the first account owns the second equipment.

5. The method according to claim 1, wherein displaying the information display area of the second virtual character in response to receiving the trigger operation on the character image of the second virtual character comprises:
receiving the trigger operation on the character image of the second virtual character when a distance between the first virtual character and the second virtual character is less than or equal to a preset distance; and
displaying the information display area in response to the trigger operation on the character image of the second virtual character.

6. The method according to claim 1, further comprising:
displaying the virtual equipment information currently worn by the second virtual character in the information display area, when an intimacy level between the first account logged in on the computer device and another account logged in on the another computer device is greater than or equal to an intimacy threshold.

7. The method according to claim 1, wherein displaying the equipment acquisition information corresponding to the first equipment comprises:
displaying a first acquisition path and the first acquisition entry as the equipment acquisition information corresponding to the first equipment, when the first equipment is acquired through a resource exchange platform and the first equipment meets the equipment acquisition condition, the first acquisition path indicating that the first equipment is acquired through the resource exchange platform, and the first acquisition entry being configured for redeeming the first equipment on the resource exchange platform; and

8. The method according to claim 7, further comprising:
displaying the resource exchange platform in response to receiving a trigger operation on the first acquisition entry, the resource exchange platform being configured for redeeming the first equipment through a virtual resource.

9. The method according to claim 2, wherein displaying the equipment acquisition information corresponding to the first equipment comprises:
displaying a second acquisition path and a second acquisition entry as the equipment acquisition information corresponding to the first equipment when the first equipment is acquired through participation in a game activity, and a current moment is within an activity deadline range of the game activity, and the first equipment meets the equipment acquisition condition, the second acquisition path indicating that the first equipment is acquired through participation in the game activity, and the second acquisition entry being configured for participating in the game activity.

10. The method according to claim 9, further comprising:
displaying an activity participation platform in response to receiving a trigger operation on the second acquisition entry, the activity participation platform being configured for participating in the game activity; and
acquiring the first equipment when participation in the game activity meets an activity equipment acquisition condition, the activity equipment acquisition condition being a condition for acquiring the first equipment through the game activity.

11. The method according to claim 2, wherein the first equipment is equipment worn by the first character part of the second virtual character; and
displaying the information display area of the second virtual character in response to receiving the trigger operation on the character image of the second virtual character comprises:
displaying the information display area in response to receiving the first trigger operation on the first character part of the second virtual character, the information display area comprising the equipment outfit display sub-area, and the equipment outfit display sub-area being configured for displaying virtual equipment information currently worn by the first character part of the second virtual character.

12. The method according to claim 11, further comprising:
displaying the equipment acquisition information corresponding to the first equipment in response to receiving a second trigger operation on the first character part of the second virtual character, the first character part wearing the first equipment, and the first trigger operation being different from the second trigger operation.

13. The method according to claim 2, wherein displaying the equipment acquisition information corresponding to the first equipment comprises:
displaying a first preview interface, the first preview interface comprising the equipment acquisition information corresponding to the first equipment, and the first preview interface being configured for previewing an effect that the first virtual character wears the first equipment.

14. The method according to claim 13, further comprising:
displaying a second preview interface in response to receiving the trigger operation on the character image of the second virtual character, the second preview interface comprising the equipment outfit display sub-area, and the second preview interface being configured for previewing an effect that the first virtual character wears the virtual equipment currently worn by the second virtual character.

15. The method according to claim 1, wherein displaying the equipment acquisition information corresponding to the first equipment comprises:
displaying an equipment acquisition path and a wearing entry as the equipment acquisition information corresponding to the first equipment when a first account logged in on the computer device owns the first equipment, and the first virtual character does not currently wear the first equipment, the equipment acquisition path being configured for indicating a mode of acquiring the first equipment, and the wearing entry being configured for controlling the first virtual character to wear the first equipment.

16. The method according to claim 15, further comprising:
displaying a wearing animation in response to receiving a trigger operation on the wearing entry, the wearing animation referring to an animation of the first virtual character wearing the first equipment.

17. A computer device, comprising one or more processors and a memory containing at least one instruction that, when being executed, causes the one or more processors to perform:
displaying a virtual scene, the virtual scene comprising a first virtual character and a second virtual character, the first virtual character being controlled by the computer device, and the second virtual character being controlled by another computer device;
displaying an information display area of the second virtual character in response to receiving a trigger operation on a character image of the second virtual character, the information display area comprising virtual equipment information currently worn by the second virtual character; and
displaying equipment acquisition information corresponding to a first equipment in response to receiving a trigger operation on the first equipment in the information display area, the equipment acquisition information comprising an acquisition entry of the first equipment when the first equipment meets an equipment acquisition condition.

18. The computer device according to claim 17, wherein the information display area comprises an equipment outfit display sub-area, and the equipment outfit display sub-area comprises an equipment picture of the virtual equipment currently worn by the second virtual character; and the one or more processors are further configured to perform:
displaying the equipment acquisition information corresponding to the first equipment in response to receiving a trigger operation on the equipment picture of the first equipment in the equipment outfit display sub-area.

19. The computer device according to claim 18, wherein the second virtual character currently wears multiple pieces of virtual equipment;
the multiple pieces of virtual equipment are separately displayed individually in the equipment outfit display sub-area; or
the multiple pieces of virtual equipment are displayed in a combined manner with a coordinated form in the equipment dressing display sub-region.

20. A non-transitory computer-readable storage medium containing at least one instruction that, when being executed, causes at least one processor to perform:
displaying a virtual scene, the virtual scene comprising a first virtual character and a second virtual character, the first virtual character being controlled by the computer device, and the second virtual character being controlled by another computer device;
displaying an information display area of the second virtual character in response to receiving a trigger operation on a character image of the second virtual character, the information display area comprising virtual equipment information currently worn by the second virtual character; and
displaying equipment acquisition information corresponding to a first equipment in response to receiving a trigger operation on the first equipment in the information display area, the equipment acquisition information comprising an acquisition entry of the first equipment when the first equipment meets an equipment acquisition condition.
